(19) United States
(12) Patent Application Publication
(10) Pub. No.: US 2014/0225747 A1
(43) Pub. Date: Aug. 14, 2014

(54) WIRELESS WATERLINE PRESSURE SENSOR SYSTEM FOR SELF-PROPELLED IRRIGATION SYSTEMS

(71) Applicant: Karlyle Haaland, (US)

(72) Inventor: Gerald L. Abts, Denver, CO (US)

(73) Assignee: Karlyle Haaland, Dalhart, TX (US)

(21) Appl. No.: 13/762,556

(22) Filed: Feb. 8, 2013

(51) Int. Cl. G08C 17/02

(52) U.S. Cl. CPC G08C 17/02
USPC 340/870.11

(57) ABSTRACT

A water pressure sensing system for self-propelled irrigation systems has a waterline pressure sensing device mounted at the outermost sprinkler in wireless communications with a master control unit (MCU) mounted elsewhere on the irrigation system. The waterline pressure sensing device includes a water pressure sensor and a processor to detect changes in waterline pressure, in addition to a short-range radio for wireless communication with the MCU. The MCU includes a short-range radio for wireless communication with the water pressure sensing device, a processor for processing the received waterline pressure status data, and a long-range transmitter for relaying this data to a remote internet-connected central computer. The remote central computer alerts mobile operator devices to inform the operator of the waterline pressure status.

### BACKGROUND OF THE INVENTION

1. Field of the Invention

The present invention relates generally to the field of self-propelled irrigation systems. More specifically, the present invention discloses a wireless system for remotely monitoring the water pressure at the outermost point of a self-propelled irrigation system.

2. Statement of the Problem

Mechanized sprinkler irrigation systems, such as center pivot and lateral move irrigation systems, are in common use. Over 250,000 exist in the United States alone. Typical systems irrigate over 100 acres to as high as 600 acres. In practice, each center pivot system is designed to deliver a certain flow rate of water (typically expressed in gallons per minute per acre) at a specific waterline pressure uniformly and precisely over the entire field served by the irrigation system. A minimum amount of end-of-system waterline pressure (or at least the presence of water in the outermost point in the waterline) is a defining variable to assure an efficient operation of a respective set of sprinkler nozzles and spray devices and, thereby, maintain a uniform and predictable water pattern over the entire length of the irrigation system. Factors such as well water draw-down and depletion, partial or complete loss of surface water sources, power unit and pump malfunctions, changes in field topography (elevation) as the span of pipe roves about the field, failure of seals and sprinkler device fittings, etc., all can negatively affect the designed amount of waterline pressure needed for an optimum water pattern and, therefore, the performance of such systems. Large farms with scattered field sites and multiple crops are typical users of mechanized irrigation systems. Pivot sites are often remote and not always served by public roads. Manually monitoring such systems by on-site inspections has been the norm. Two to three daily on-site visits by operators using 4WD pickup trucks, SUVs or ATVs are considered minimal to observe the end-of-system water pressure status (typically by visually inspecting the water delivery spray pattern and reading analog pressure gauges located at the center pivot point and on a last sprinkler outlet of each pivot) and to respond to shutdowns and breakdowns, and in order to maintain irrigation schedules that meet crop-watering requirements. An unnoticed water pressure drop and the related flow loss may result in substantial loss of the crop.

In particular, center pivot irrigation systems are designed to apply a specific amount of water to the whole field in each 360 degree rotation of the roving pivot arm. Normal water applications typically take three to four days to complete and longer for larger fields. In terms of remote control and monitoring, the primary need is to know the status, (i.e., is the irrigation system moving, and is the end-of-system waterline pressure adequate to provide optimum operation of sprinkler devices along the full length of the pivot arm). Loss of design water pressure can occur from a plethora of causes, but in the western corn belt and the high plains area, where the majority of center pivots are used, a primary cause of pressure loss is the seasonal drop in well water pumping levels that gradually causes a decrease in water pressure and resulting system water flow. In a single irrigation season, these gradual declines in water delivery capacity can require replacing the nozzles of the water discharge (sprinkler) devices to restore a minimum waterline pressure at the new, reduced rate of flow. In many sections of the high plains that are served by underground aquifers, years of pumping have continued to deplete the amount of water available to pump as well as to increase the depth to water in most irrigation wells. Therefore, water declines must be watched carefully by monitoring waterline pressures so operators can act in a timely manner to re-nozzle sprinkler systems with smaller orifices to restore minimum pressures and adjust pivot ground speeds, or even abandon pie shaped sectors of the irrigated field to compensate for any reduced rate of pumping. It is not uncommon for such sprinklers to be re-nozzled multiple times in a single growing season. In addition to declining pumping levels, water delivery systems can be affected by electrical power surges, blown or leaking gaskets and boots, etc. Water delivery systems powered by natural gas engines are subject to gas line pressure fluctuations and wet ignition circuits that can cause internal combustion engines to malfunction or shutdown, resulting in loss of water delivery pressure. Sand and other debris can accumulate in the outmost sections of the waterline and cause plugged sprinkler nozzles. Frequent inspection of actual end-of-system waterline pressure is critical to assure that water delivery is meeting expectations. Thus, the end-of-system waterline pressure of mechanized irrigation systems needs to be continuously monitored throughout the irrigation season in order for operators to take corrective action to maintain uniform water application and critical watering schedules for optimum yield and crop quality.

Over the last thirty years, several remote monitoring systems have been put to commercial use. All use telemetry and all have required wired interfaces between: (a) the control circuitry of the center pivot main panel or the circuitry of span-mounted electrical enclosures that control individual tower movement (typically called a remote terminal unit (RTU) or master control unit (MCU)); and (b) the sensors installed on the pivot that return digital and analog input data (i.e., pivot direction, speed, water pressure, etc.) via hardwired connections from each sensor back to the monitoring MCU.

Typical MCUs that are used to monitor self-propelled irrigation systems include a terrestrial or satellite radio transmitter for long-range communication to internet-connected computer servers. Telemetry systems sold by irrigation system manufacturers often require electronic and programmable center pivot main panels (or other hardware retrofits) located at the center pivot point for radio telemetry with on-farm base-station computers, running proprietary software. Most include remote control functions and some monitor pivot position using an electronic encoder or resolver (i.e., devices rotated at the pivot center point by the movement of the first drive tower) to sense approximate, end-of-system pivot arm position in degrees from north. The pivot arm position, in turn, is used by a programmed set of instructions stored in the pivot main panel or at a base station computer to initiate control changes such as pivot speed changes, pivot direction changes, turning the pivot off, end guns on, etc., all based on pivot arm position.

A more recent development by third-party vendors and adopted by some center pivot manufacturers has been to use an end-of-system MCU with a GPS (global positioning system) receiver in lieu of the mechanical encoder or resolver at the center pivot to determine pivot arm position (i.e., azimuth from the center pivot point to the outermost drive tower structure). This allows more precise control of the functions of a center sprinkler based on end-of-system pivot arm position relative to the center point. Some center pivot manufacturers have taken advantage of GPS technology while retaining their legacy center pivot point main panels, in lieu of end-of-system MCUs, by using power line carrier signaling methods to transmit coded GPS data from a GPS receiver placed at the outermost tower structure back to the centrally-located main panel. This added complexity and cost is offset by being able to avoid complete obsolescence of existing main panels.

Under pressure from third-party vendors, the placement of the MCU at the end-of-system (last tower structure) rather than at the main panel located at the center pivot point has been cautiously accepted by most center pivot manufacturers. The obvious advantage is to more accurately track pivot arm position using GPS as well as providing a lower cost means (compared to programmable main panels) to remotely control most functions of the pivot (e.g., stop, start, speed, direction and end-gun activity) from the end of the system.

Significantly, the end-of-system placement of the MCU also facilitates a much improved location for monitoring pivot waterline pressure as compared to monitoring pressure at the center pivot point, where main panels and pressure sensors are typically located. An end-of-system waterline pressure operating below the design minimum signals a condition that significantly affects water delivery spray patterns and can readily result in crop stress and yield loss. Operating a pivot at an end-of-system waterline pressure below a design minimum can exponentially affect crop loss due to the disproportionate number of acres irrigated by the outer-most spans of the roving pivot arm, the spans first affected by a waterline pressure loss. Therefore, it is critical to monitor and maintain a minimum design waterline pressure at the outermost sprinkler outlet, not at the center point.

The end-of-system placement of the MCU is typically at the last drive tower. That is where the last electrical control tower box is located and it is into this electrical enclosure that the MCU cables and wires are conventionally routed for connection to the power and control circuits of the pivot. In turn, for these end-of-system monitors, the typical placement of the waterline sensing device is adjacent to or even mounted to the MCU enclosure. This is a big improvement to the legacy practice of monitoring waterline pressure at the center point. However, the critical last sprinkler outlet is located at the outermost point of the overhang pipe, often well beyond the last drive tower. In fact, the overhang pipe can be cable suspended to extend over eighty-feet beyond the last drive tower. Therefore, it is a further improvement to monitor waterline pressure at the outermost sprinkler outlet at the end of the overhang pipe. But, this can require 100 feet or more of electrical cable between the MCU mounted at the last tower structure and the water pressure sensor installed at the end of the overhang pipe. Furthermore, installing the connecting cable from the MCU to the waterline pressure sensor can require the use of a ladder, front loader, boom truck, etc., in order to secure the required cable or wire harness to the overhang pipe which is typically fifteen feet or more above ground and over the crop canopy. For optimum placement of the waterline pressure sensor device, the connecting cable (wire harness) must also be run down vertically from the end of the overhang pipe to the bottom of the outermost sprinkler drop line and be connected to the waterline pressure sensing device, optimally installed just above the outermost sprinkler nozzle. In practice this is rarely done. Providing a 100 foot cable with every waterline pressure sensing device would be a waste if the overhang was shorter than eighty feet, and most are. Typically, a compromise is struck whereby the waterline sensor device is simply located at the last tower and, in turn, the overhang water delivery pipe is simply not monitored for pressure and optimum water delivery. Depending on system length, the overhang pipe can irrigate over 10% of the acres in a pivot field. Therefore, this practice leaves a critical and significant portion of the water delivery system unmonitored for waterline pressure.

Without regard to the length of the overhang water delivery pipe, the suboptimal prior art method of remotely monitoring waterline pressure near the end of the system rather than at the end is accepted in practice. This may be partially due to the fact that it is still a significant improvement to the traditional practice of monitoring waterline pressure at the center point, and also because vendors can avoid the added expense and installation difficulty of placing the waterline pressure sensing device just above the outermost sprinkler nozzle. Simple analog pressure gauges are often used to visually monitor waterline pressure, and where no wires needed, are typically placed just above the last sprinkler nozzle for ground level, to allow on-site visual inspection from just beyond the crop canopy at ground level. Regardless of placement, waterline pressure sensing devices used with remote monitoring systems have always necessitated installation and connection of cables between the MCUs and the water sensing devices. This requires water-tight electrical connections inside the MCU located at an outer span support tower. A degree of expertise and electrical wiring competency is required for safe and correct installation wires that provides the needed functionality and meets the requirements of the National Electrical Code for center pivot and lateral move sprinklers. Furthermore, the sensitive electronics needed to remotely monitor waterline pressure status by this hardwired method are easily interfered with and can be damaged from improper installation, electrical power surges and lightning events. As a result, such installations, if used at all, tend to be costly to maintain.

Therefore, a need exists for a universal, self-contained, wireless waterline pressure sensing device that does not require a cable connection or wire harness between the pressure sensing device (i.e., pressure transducer, pressure switch, etc.) and the MCU. A need further exists to provide a self-contained water pressure sensing device that simply mounts to an outer-most sprinkler drop line just above the last nozzle device and below any pressure-regulating device, and requires no wires or electrical devices to be connected to a monitoring MCU. A need further exists to make the pressure monitoring device self-contained with independent power, and with the ability to independently detect waterline pressure and thereby water delivery status, and to transmit changes to waterline delivery status by means of a small, low powered radio transmitter to a span-mounted MCU that also includes a small, low-powered radio transmitter. Such low-powered radio transmitters are conventional and readily available for this application (e.g., XBee brand). A need further exists for a universal water pressure sensing device that is accessible while working at ground level, without electrical wiring know-how and is, therefore, simple to install and to relocate to alternative center pivots for maximum utility and cost-effectiveness.

3. Solution to the Problem

In response to the shortcomings of the prior art systems used to monitor center pivot waterline pressure discussed above, the present invention employs a self-contained water pressure sensor that includes a small, low powered radio transmitter capable of transmitting water pressure status changes to a remote MCU mounted elsewhere on the irrigation system (e.g., near the last tower structure of a center pivot sprinkler). This is in lieu of a wired interface between the pressure sensing device and the MCU. In turn, the MCU communicates waterline pressure status data and other operating status parameters conventionally by long-range terrestrial or satellite telemetry to a remote computer server.

The pressure sensing device is self-contained (e.g., including a battery, solar charger, processor and local short-range radio for communications to a MCU mounted elsewhere on the pivot). Because it does not require any wired connections to the MCU or other electrical circuits of the irrigation system, the present invention can be readily located at a point in the waterline that is optimal to the critical task of monitoring system water pressure—at the very end of the water delivery line.

In particular, the waterline pressure sensing device can be easily mounted just below any pressure-regulating device and above the outermost sprinkler at the lowest point on the respective drop line. Thus, the wireless pressure sensing device can eliminate the need to install a wire harness outside of the self-contained MCU enclosure and provides improved flexibility for achieving optimum placement of the water pressure sensing device to the benefit of irrigators.

The present invention dovetails with one of the inventor's prior patented products (U.S. Pat. No. 7,584,053 to Abts) and with the inventor's U.S. Provisional Patent Application 61/597,567 and U.S. patent application Ser. No. 13/633,264, that address the need for a wireless interface between monitored pivots and the end-of-system monitoring MCU. Specifically, the prior patent and applications describe a wireless system for monitoring center pivot movement through the use of a current sensor, an accelerometer and a GPS receiver for coordinate data. These prior art disclosures simplify the installation of remote monitors and improve the overall reliability of monitoring center pivot on/off status, position and direction status. They do not, however, address the need to monitor water pressure remotely from the MCU without a wire harness connecting the water pressure sensing device to the MCU.

### SUMMARY OF THE INVENTION

The present invention is a wireless, self-contained waterline pressure sensing device for monitoring water pressure in a self-propelled irrigation system that can be mounted at the outermost sprinkler in the irrigation system. The waterline pressure sensing device includes a water pressure sensor, processor, and short-range radio transmitter (e.g., XBee radio modules or equivalent). This invention also employs a master control unit (MCU) mounted elsewhere on the irrigation system that is equipped with a short-range radio to receive data regarding the waterline pressure status from the waterline pressure sensing device. The MCU also typically includes conventional, long-range telemetry via either terrestrial or satellite means. Changes in the monitored status of the irrigation system processed by the MCU, including waterline pressure status can be transmitted over-the-air to a remote central computer and recorded in a central database used to update website pages that display pivot status and history. Irrigators and others can, in turn, be alerted wherever there is a change in the pivot status, including waterline pressure status, via voice telephone messages, e-mail messages, text messaging to cell phones, PDAs, iPads, pagers and other portable internet-connected devices.

The waterline pressure sensing device requires no wired connections to the center pivot control or power circuitry, nor any wired connections to the MCU. To facilitate short-range radio communications, the device can be located anywhere within 4,000 feet in line of sight to the monitoring MCU. In the intended practice, the waterline pressure sensing device is attached to the outermost sprinkler on the irrigation system. Because the device is wireless, its placement is simple and flexible, making optimum placement easy and attainable compared to the present art that requires a wired interface from a conventional pressure sensing device back to a MCU mounted at the last tower structure or elsewhere on the irrigation system.

In another embodiment multiple waterline pressure devices could be installed at alternative points within the waterline of the pivot or other points in the waterline delivery such as at pump sites or valve sites. The limitation to monitoring pressure at such alternative sites would be the line-of-site telemetry of the short-range radios used. In cases of multiple waterline pressure monitoring sites conventional MESH radios could be used in lieu of point-to-point radios in order to extend radio coverage as needed.

The waterline pressure sensing device can be mounted to a sprinkler outlet on top of the span pipe near the last drive-tower structure of the center pivot. A suitable location to sense waterline pressure, but not the optimal location since the remaining overhang pipe, that extends up to eighty feet beyond the last drive tower structure, would not be covered for waterline pressure monitoring.

In another embodiment, the waterline pressure sensing device is mounted to the outermost sprinkler on the pipe span that includes the overhang pipe (the one farthest from the center point). This is an optimum location from which to monitor waterline pressure status since the entire water delivery system, including the overhang pipe all the way to the last hose drop serving the last nozzle, is upstream from this location and thus the entire water delivery system is monitored for waterline pressure status.

An additional benefit can be achieved by placing the waterline pressure sensing device on the discharge side of any pressure regulators that are typically used with irrigation systems. Pressure-regulating devices control the waterline pressure at the discharge side of the regulator to a specified maximum pressure (e.g., 10 psi or 15 psi). This prevents over-pressurization just ahead of the sprinkler nozzle. By monitoring the pressure at the discharge side of the regulator, the present invention can be used to detect a faulty or failed regulator in need of replacement. Failed regulators can cause serious and negative water delivery pattern deviations.

Monitoring pivot waterline pressure using the waterline pressure sensing device does not require a hard-wire interface to the pivot control or power circuitry, nor does it require a wired interface from the waterline pressure sensor device back to the monitoring MCU at the last tower structure that is monitoring pivot status changes. The present invention will work equally well on any electrically powered center pivot or lateral move sprinkler with electrical circuits controlling and powering the movement of the outer spans.

It is a further object of the present invention to provide a wireless interface wireless waterline sensing device that can be used with both center pivot irrigation systems and lateral (linear) move systems, including hydraulically-driven pivot and lateral move sprinklers.

The waterline pressure sensing device is self-contained. The low-power design of the device facilitates inclusion of a short-range radio powered by a lithium-ion battery with or without a solar panel for recharge, both of which are incorporated into the device housing. With the waterline pressure sensing device mounted at the lowest point of a hose-drop serving the outermost sprinkler nozzle, the device will be under the shadow of the crop canopy for much of the growing season. However, the battery is designed to provide adequate power to the waterline pressure sensing device without regular solar recharge. Once the crop is harvested the solar array will recharge the battery as necessary for each successive growing season or the battery can simply be replaced at the beginning of the irrigation season.

With scarce and expensive labor and high vehicle operating costs, the waterline pressure sensing device when paired with a monitoring MCU offers the operators of mechanized irrigation systems an improved, low cost method of: (a) remotely monitoring the waterline pressure of center pivots to determine if they are running with optimum designed waterline pressure; and (b) using a central server with internet connectivity and wireless telemetry to provide a method of alerting operators to waterline pressure status changes in a timely manner.

It is a further object of the present invention to remotely sense water delivery to an outermost pipe of the center pivot by means of a wireless waterline pressure sensing device paired with a MCU by means of a low-powered short-range radio that detects the presence of water delivery, and for the MCU to send such water status data by long distance telemetry to a central control computer operated by a third party service operator for the benefit of respective pivot operators anywhere.

It is a further object of the present invention to upload the information sent from the wireless waterline sensing device using short-range radios to a MCU for delivery to a central control computer to be processed for display content of discrete website pages for respective end users, the content of which will include graphic and tabular data displays of pivot water pressure status (color-coded circular graphics indicating pivot and water delivery status, field by field, both historical and in real time).

It is a further object of the present invention to provide a universal, self-contained, wireless interface remote waterline sensing device that is economical to manufacture, simple to install and relocate, efficient in use, capable of being retrofit to any of a number of different center pivot irrigation systems without modification, that is reliable, and well suited to operate on both center pivots and linear move systems in all environments, anywhere in the world.

The water pressure sensor device is connected to the pressurized waterline and is used to simultaneously monitor and record the pressure of the delivery of water (minimum pressure to an outermost sprinkler nozzle). Based on a change in status or on a timed basis, data packets of center pivot waterline pressure status (determined by use of the wireless, self-contained pressure sensing device), can be transmitted wirelessly over short-range radios. In turn, the MCU receiving the status data can further process the data and deliver such data by means of a conventional, long range terrestrial or satellite radio telemetry system to an internet-connected, central control computer to remotely determine the waterline pressure status over a span of time.

The waterline pressure status data are, in one embodiment, event-driven whenever the MCU determines that a pivot's waterline pressure status has changed by a preset percentage of the range of the water pressure sensor. In addition, the data can include time stamps for all recorded status of monitored conditions or parameters, such as the current GPS coordinates indicating pivot arm position. All status changes and other data packet reports can be processed at the central server using appropriate software and data can be detailed and summarized for the benefit of each irrigator. The data can be prepared for presentation via the internet. The internet content can be conventionally uploaded to discrete pages of a website(s) for use by pivot managers, operators and others and can include summary and detail displays of water pressure status, running or stopped pivot status, speed of travel, direction of travel, rate of water application and pivot arm position for individual pivots and for groups of pivots.

Additionally, the waterline pressure and other pivot status data collected by the central control computer can be delivered to irrigation system managers and operators and others from the central server over conventional mobile telemetry platforms, including any internet-connected communication device, alphanumeric paging systems, text messaging services and over other portable wireless devices available to mobile center pivot operators that are capable of receiving e-mail, SNTP, SMTP, FTP or other wireless messaging.

Additionally, the waterline pressure and other status data collected by the central control computer can be delivered verbally to center pivot managers and operators and others using interactive voice response (IVR) or other conventional voice messaging techniques and devices.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is an overview pictorial diagram showing a center pivot irrigation system 10 having a master control unit 30 (MCU) positioned on the outermost drive tower 15 of a pivot span 18 and having a waterline pressure sensing device 40 located just above the outermost sprinkler nozzle 60 for the purpose of monitoring waterline pressure 16, and using a wireless radio path 70 to communicate between the waterline pressure sensing device 40 and MCU 30.

FIG. 2 is a flowchart of the main processing steps used by the wireless waterline pressure sensing device 40 and the MCU 30 to remotely monitor and transmit changes in water pressure status.

FIG. 3 is a block diagram of an MCU 30 with a long-range radio 31 for communications with a remote central computer over terrestrial or satellite communication system, and a short-range radio 33 for communication with the waterline pressure sensing device 40.

FIG. 4 is a block diagram of the waterline pressure sensing device 40 with a short-range radio 43 for communication with the MCU 30.

### DETAILED DESCRIPTION OF THE INVENTION

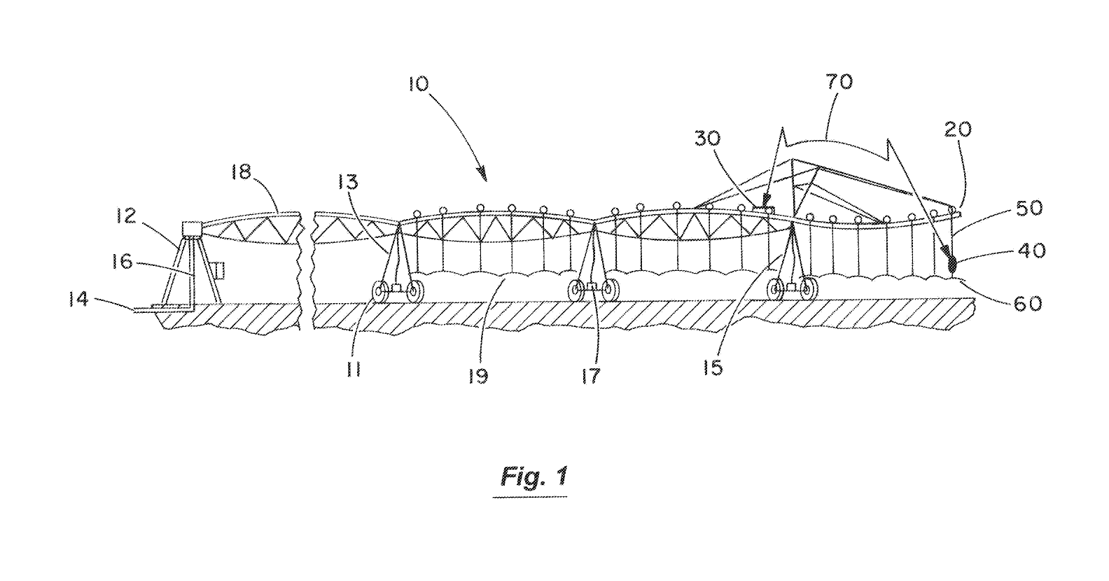

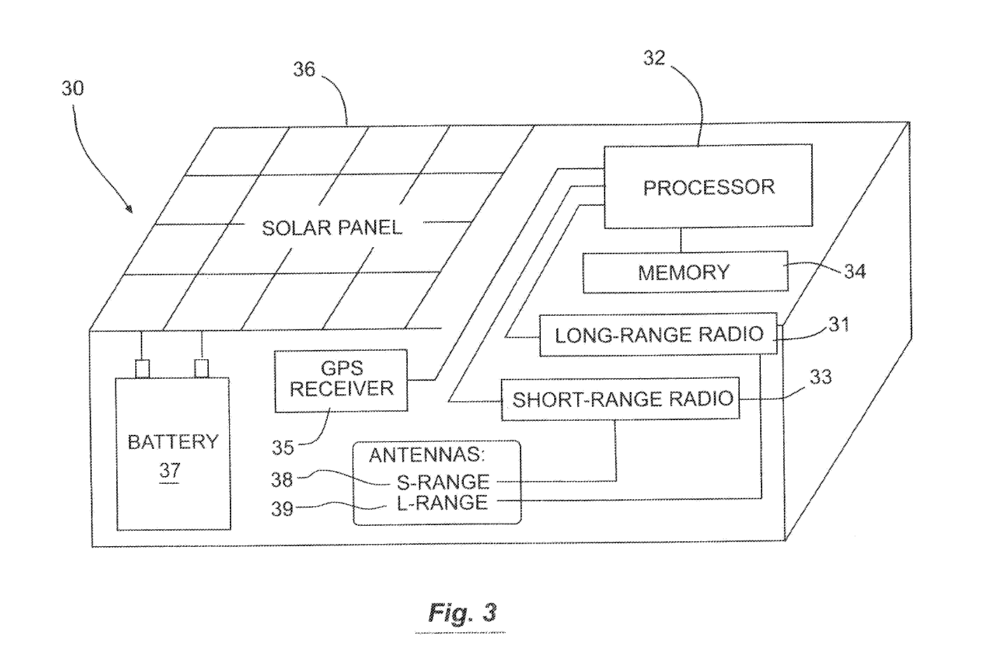

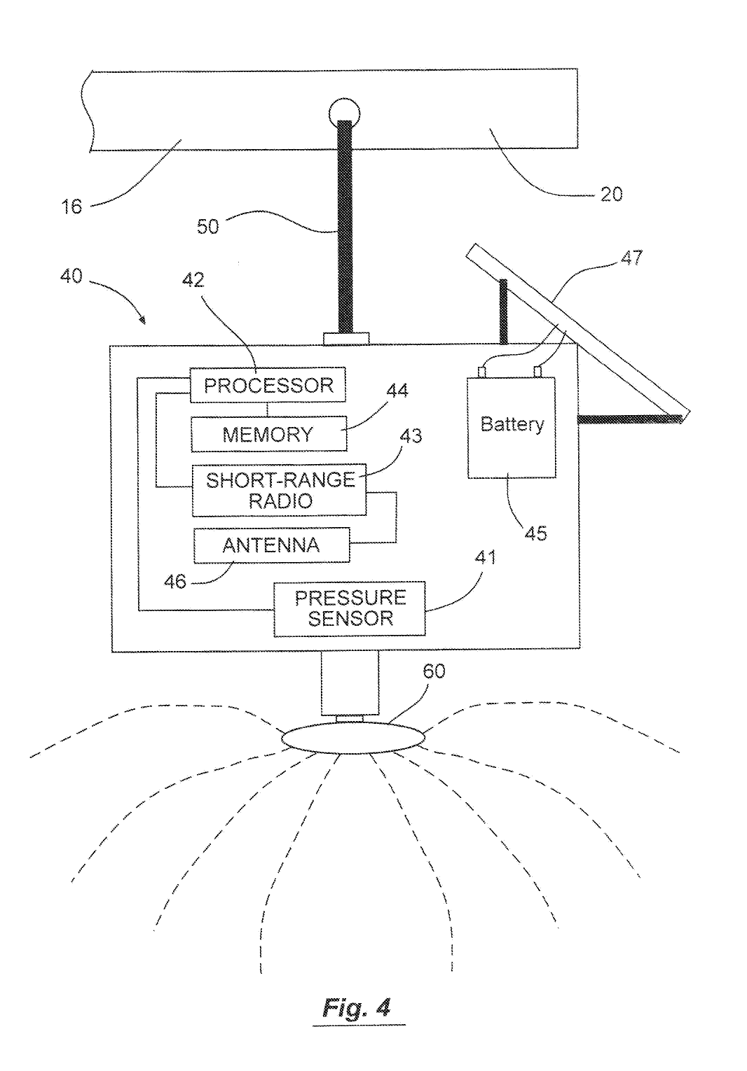

FIG. 1 is an overview pictorial diagram showing a center pivot irrigation system having a master control unit 30 (MCU) positioned on an outer-most drive tower 15 of a pivot span 18 and having a waterline pressure sensing device 40 located on an outer-most sprinkler nozzle 60 for the purpose of monitoring waterline pressure 16 and using a wireless radio path 70 to communicate between the waterline pressure sensing device 40 and the MCU 30. The invention includes an MCU 30 equipped with a short-range radio 33 (shown in FIG. 3) that communicates locally to a short-range radio 43 (shown in FIG. 4) that is housed in the enclosure of the wireless pressure sensing device 40. Xbee brand radios (commercially available from Digi International of Minnetonka, Minn.) or equivalents are suitable for this purpose. The MCU 30 also includes long-range radio 31 (shown in FIG. 3) for two-way communication with terrestrial or satellite networks.

FIG. 1 details the mechanized irrigation systems 10 that are conventional and commercially available from a number of different manufacturers. The center pivot system 10 shown in FIG. 1 is used for purposes of illustrating and explaining the present invention. Mechanized irrigation systems 10 are commonly used in a center pivot configuration such as shown in FIG. 1 wherein the center pivot point 12 receives pressurized water 14 for delivery through a fluid delivery system 16 that includes spans of jointed pipe 18 supported by wheeled drive towers 13 for delivery onto the ground through a series of sprinkler nozzles 19. Such center pivot irrigation systems 10 typically have wheels 11 and motors 17 at the pivot drive towers 13. The center pivot pipe spans 18 and series of pivot drive towers 13 can add up to any desired length from the center pivot point 12 to the pivot end position 20. Another type of mechanized irrigation system moves in a lateral or linear orientation across a field. The present invention is not limited in application to the type of mechanized irrigation system (center pivot 10 or lateral move).

Referring to FIG. 3, the MCU 30 includes a battery 37, a solar panel 36, a short-range radio 33 with an antenna 38, a long-range radio 31 with an antenna 39, and a GPS receiver 35. Referring first to FIG. 1, the GPS unit 35 is used to track the position in degrees from north of the roving pivot 10 from the stationary center pivot point 12. The end-of-system MCU 30 is typically located on the outermost drive tower 15 of the irrigation system 10. As illustrated, the waterline pressure sensing device 40 is installed in the waterline 16 at the end position 20 of the pivot, and at the lower end of the last drop line 50, just above the last spray nozzle 60. This is the optimum placement of the water pressure sensing device 40 so as to measure the pressure status of the complete waterline 16 of the pivot 10.

In order to easily locate the pressure sensing device 40 at an end-of-system location 20, all connecting wires and terminals between water pressure sensing device 40 and the MCU 30 are eliminated through the use of short-range radios 33 and 43, shown in FIGS. 4 and 5, respectively. These short-range radios 33, 43 are housed in the respective enclosures of the water pressure sensing device 40 and the MCU 30. The short-range radios 33, 43 communicate via wireless path 70.

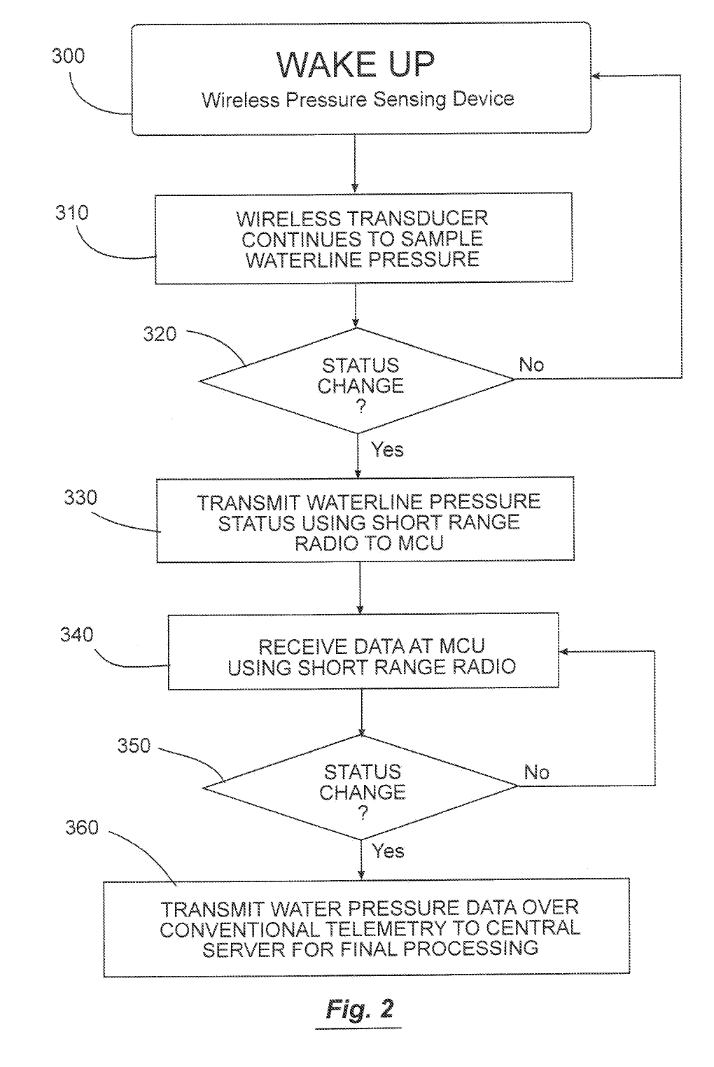

In FIG. 2, the method of operation of the waterline pressure sensing device 40 and MCU 30 is set forth. The processor 42 in the waterline pressure sensing device 40 wakes up in step 300. An internal clock or timer causes the processor 42 to power-up at predetermined intervals, such as every minute. This wake-up feature 300 causes the processor to sample the water pressure reading 310 from the pressure sensor 41 in the waterline pressure sensing device 40 and record the water pressure readings in memory 44 (shown in FIG. 4). This is conventional and conserves the battery within the device 40. In step 320, the processor 42 uses the current reading 310 and the previous reading(s) stored in memory 44 to determine whether a predetermined change in the waterline pressure status has occurred based on the water pressure readings. For example, whenever a water pressure reading 310 changes by a certain percentage of the pressure range monitored, the processor 42 using step 320 transmits the event over the short-range radio 43 using step 330 to the MCU 30. Alternatively a pressure switch can be set to operate as an on/off switch. In this embodiment, the processor 42 in step 310 does not take and compare individual pressure readings. Rather, a pressure threshold for wet and dry (yes/no) status can be set for each individual pivot situation and used in step 320.

In another example, using the processor 42 and a pressure transducer 41 that outputs actual pressure in PSI over a range of 0-25 PSI, the prior status stored in memory 44 could have been a pressure reading of 15.0 PSI. If the waterline pressure sensing data 310 currently being delivered indicates a pressure of 12.0 PSI, a status change 320 of −3.0 PSI has occurred, resulting in a 12% change ( 3/25) and a “yes” condition is assumed. Or, the prior status store in memory 44 could have been 12.0 PSI in which case, if the waterline pressure sensing data step 310 currently being delivered indicates 12.0 PSI, then a status change 320 of 0.0% has occurred, resulting in a “no” condition. In FIG. 2, the transmit data step 330 using the short-range radio 43 and antenna 46 is event driven, so that whenever the waterline pressure sensing device 40 determines that waterline pressure reading 310 of a pivot 10 at the waterline position 60 has changed 320 by a predetermined percentage over a preset period of time (in the first example with a prior reading of 12.0 PSI and a current PSI reading of 15.0, the percentage change is +12%), the status change result is “yes” and a data packet of waterline pressure status is sent by the short-range radio 43 in the waterline pressure sensing device 40 in step 330, and is received in step 340 by the short-range radio 33 and its antenna 38 at the MCU 30.

In FIG. 2, the MCU 30 receives the changed waterline pressure status 320 from the waterline pressure sensing device 40. The changed status data from step 320 can be sent via a data packet 330 using wireless communications 70 to the MCU 30. The data packet 330 could include data stored in memory 44 of prior waterline pressure status readings taken at timed intervals, but not previously sent based on “changed” status 320 criteria used by the processor 42 in the waterline pressure sensing device 40.

Note that pressure sensing devices 40 operate over a range of pressures (e.g., 0-25 psi or 0-50 psi). The percentage change in pressure for the pressure sensing device would be typically calculated by using the changed pressure value (3 psi in the above example) as the numerator and the upper range of the pressure sensing device (25 PSI in the above example) as the denominator, resulting in a percentage change of 3/25 or 12%.

Referring to FIG. 2, the waterline pressure data is transmitted in step 330 using the short-range radio 43 of the waterline pressure sensing device 40, and received by the short-range radio 33 of the MCU 30 in step 340. In step 350, the processor 32 in the MCU 30 can simply forward all received waterline pressure data 310 using step 360 to transmit the waterline pressure data 310 over conventional long-range telemetry using its long-range radio 31 and antenna 39 to a remote central computer in step 350 for final processing.

In another embodiment, the waterline pressure data 310 received by MCU 30 in step 340 could be further evaluated by the processor in MCU 30 using step 350 before transmitting to the central computer in step 360. For example, the waterline pressure data 310 received by MCU 30 in step 340 could be compared by the processor in the MCU 30 to a prior waterline pressure reading 310 stored in its memory 34 using different criteria in step 350 as compared to the criteria used by the processor in the waterline pressure monitoring device 40 in step 320. In other words, a 1% change in waterline pressure status in step 310 could result in a status change 320 of “yes” and the data 310 would be transmitted in step 330 to the MCU 30 and received in step 340. However, the criteria used by the processor 32 in the MCU 30 in step 350 could be different from the criteria used by the processor 42 in the waterline pressure sensing device 40 in step 320. For example, the MCU 30 in step 350 may require a 3%+ change in pressure before transmitting water pressure data 310 to the central server using step 360. Because different criteria could be used by the processor 32 of the MCU 30 to determine if the waterline pressure status data 310 is to be transmitted to the remote central computer in step 360, not all waterline pressure data 310 transmitted by the short-range radio 43 in step 330 and received by the short-range radio 33 in the MCU 30 in step 340 would, in turn, be transmitted to the remote central computer in step 360 using the long-range radio 31.

FIG. 4 is a block diagram of the waterline pressure sensing device 40. Its components include a water pressure sensor 41, processor 42 with memory 44, short-range radio 43 with an antenna 46, and a battery 45 powering the electrical components. Optionally, the battery 45 can be charged by a solar array 47. As fully discussed above and shown in FIG. 1, the waterline pressure sensing device 40 is located at or near the end 20 of the waterline 16 of the center pivot 10 and preferably at the lower end of the drop line 50 just above the sprinkler 60. It is also preferably a self-contained, universal device that will work with any of a number of conventional pivot or lateral move irrigation systems 10 from a wide variety of manufacturers. The term “self-contained” means that the waterline pressure sensing device 40 does not interface to the electronics or the wiring of the control or power circuitry for the mechanized irrigation system 10. It provides a self-contained operation independent of, and isolated from the electrical circuitry of the irrigation system 10. The waterline pressure sensing device 40 does not interface with any control electronics of the irrigation system 10. It is, therefore, easily installed and easily relocated to different center pivots to maximize water pressure monitoring benefits.

It is understood that while a self-contained waterline pressure sensing device 40 has been shown and described in its preferred embodiment, it is also possible to locate elements, such as the solar array 47 and antenna 46, remotely from the unit. In which case, they can be connected to the waterline pressure sensing device 40 by suitable cables and connectors.

The above disclosure sets forth a number of embodiments of the present invention described in detail with respect to the accompanying drawings. Those skilled in this art will appreciate that various changes, modifications, other structural arrangements, and other embodiments that could be practiced under the teachings of the present invention without departing from the scope of this invention as set forth in the following claims.

I claim:

1. A wireless waterline pressure sensor system for use in a self-propelled irrigation system having a waterline carrying water to a plurality of outlets for irrigation, said wireless waterline pressure sensor system comprising:
a waterline pressure sensing device having:
(a) a water pressure sensor hydraulically interfaced with a waterline outlet of the irrigation system to sense the waterline pressure;
(b) a short-range radio;
(c) a processor receiving waterline pressure readings from the water pressure sensor, generating data indicative of the waterline pressure status, and controlling the short-range radio to transmit the waterline pressure status data; and
(d) a self-contained housing containing the water pressure sensor, short-range radio and processor mounted proximate to the waterline outlet of the irrigation system; and
a master control unit (MCU) mounted to the irrigation system remote from, and without a wired connection to the waterline pressure sensing device, said MCU having:
(a) a short-range radio communicating with the short-range radio of the waterline pressure sensing device;
(b) a long-range radio; and
(c) a processor receiving waterline pressure status data from the short-range radio of the MCU, and controlling the long-range radio to transmit data to a remote central computer if a predetermined change in the waterline pressure status has occurred based the waterline pressure status data.

2. The system of claim 1 wherein said waterline pressure sensing device is placed at an outermost point of the waterline, and remote from the MCU.

3. The system of claim 1 wherein the waterline pressure sensing device is placed at the lower end of a drop hose and above the sprinkler of the drop hose.

4. The system of claim 1 wherein the waterline pressure status data transmitted by the short-range radio of the waterline pressure sensing device comprises a timed series of waterline pressure readings by the waterline pressure sensor, and wherein the processor of the MCU controls the long-range radio to transmit data to a remote central computer if the waterline pressure status data indicates a change in waterline pressure status.

5. The system of claim 1 wherein the processor of the waterline pressure sensing device analyzes a timed series of waterline pressure readings by the waterline pressure sensor, and controls the short-range radio of the waterline pressure sensing device to transmit waterline pressure status data to the MCU in the event of change in said waterline pressure readings.

6. The system of claim 1 wherein the processor of the MCU controls the long-range radio to transmit data to a remote central computer if the received waterline pressure status data indicates a waterline pressure outside of a predetermined limit.

7. The system of claim 1 wherein the processor of the waterline pressure sensing device controls the short-range radio of the waterline pressure sensing device to transmit data to the MCU if the waterline pressure reading is outside of a predetermined limit.

8. A wireless waterline pressure sensor system for use in a self-propelled pivot irrigation system having: a center pivot, a waterline carrying water for irrigation extending radially outward from the center pivot on a support structure above the crop canopy, and including a number of drop lines extending downward at intervals along the waterline with a sprinkler at the lower end of each drop line; said wireless waterline pressure sensor system comprising:
a waterline pressure sensing device having:
(a) a water pressure sensor hydraulically interfaced with the outermost drop line of the irrigation system to sense the water pressure at the sprinkler;
(b) a short-range radio;
(c) a processor receiving waterline pressure readings from the water pressure sensor, generating data indicative of the waterline pressure status, and controlling the short-range radio to transmit the waterline pressure status data; and
(d) a self-contained housing containing the water pressure sensor, short-range radio and processor mounted at the lower end of the outermost drop line of the irrigation system; and
a master control unit (MCU) mounted to the irrigation system remote from, and without a wired connection to the waterline pressure sensing device, said MCU having:
(a) a short-range radio communicating with the short-range radio of the waterline pressure sensing device;
(b) a long-range radio; and
(c) a processor receiving waterline pressure status data from the short-range radio of the MCU, and controlling the long-range radio to transmit data to a remote central computer if a predetermined change in the waterline pressure status has occurred based the waterline pressure status data.

9. The system of claim 8 wherein the MCU is attached to an outer drive tower of the pivot irrigation system above the waterline pressure sensing device.

10. The system of claim 8 wherein the waterline pressure status data transmitted by the short-range radio of the waterline pressure sensing device comprises a timed series of waterline pressure readings by the waterline pressure sensor, and wherein the processor of the MCU controls the long-range radio to transmit data to a remote central computer if the waterline pressure status data indicates a change in waterline pressure.

11. The system of claim 8 wherein the processor of the waterline pressure sensing device analyzes a timed series of waterline pressure readings by the waterline pressure sensor, and controls the short-range radio of the waterline pressure sensing device to transmit waterline pressure status data to the MCU in the event of change in said waterline pressure readings.

12. The system of claim 8 wherein the processor of the MCU controls the long-range radio to transmit data to a remote central computer if the received waterline pressure status data indicates a waterline pressure outside of a predetermined limit.

13. The system of claim 8 wherein the processor of the waterline pressure sensing device controls the short-range radio of the waterline pressure sensing device to transmit data to the MCU if the waterline pressure reading is outside of a predetermined limit.

14. The system of claim 8 wherein the data transmitted to the remote central computer contains waterline pressure data received by the MCU from the waterline pressure sensing device.
